(19) United States
(12) Patent Application Publication
(10) Pub. No.: US 2008/0073878 A1
(43) Pub. Date: Mar. 27, 2008

(54) BRAKE SYSTEM OF STROLLER

(75) Inventor: Weiqiong Li, Kunshan (CN)

Correspondence Address: RICHARD M. GOLDBERG, 25 EAST SALEM STREET, SUITE 419, HACKENSACK, NJ, 07601, US

(73) Assignee: DELTA ENTERPRISE CORP., New York, NY (US)

(21) Appl. No.: 11/751,169

(22) Filed: May 21, 2007

(30) Foreign Application Priority Data
Sep. 26, 2006 (CN) 200620076623.8

(51) Int. Cl. B62B 9/08

(52) U.S. Cl. 280/642; 188/20

(57) ABSTRACT

A brake system of a stroller includes a wheel axle as well as a wheel seat and a wheel hub installed on the wheel axle; a brake crank is pivot jointed with the wheel axle; the wheel hub is provided with a multiple of brake grooves along the circumference direction; the wheel seat and the brake crank are provided with two brake holes and two arc-shaped grooves corresponding to the brake grooves, respectively; the arc-shaped groove is provided on the edge with an inclined ear extruding along the axial direction; a slope of the inclined ear is provided at the higher end with a stretch of terrace; the two brake holes are provided with a brake lever, respectively, which is inserted from the arc-shaped groove and always pushes against into the brake groove under the action of a pressing spring; the two brake levers are connected with an iron ring at the inner end of the inner side of the brake crank; the iron ring is provided with a stop block installed radially corresponding to the inclined ear; the stop block is against a slope of the inclined ear; and this apparatus is of a double-brake structure, thus greatly improving brake reliability and safety.

### FIELD OF THE INVENTION

The present utility model relates to a brake apparatus for baby carriages.

### BACKGROUND OF THE INVENTION

The brake apparatus of baby carriages currently available on the market comprises a wheel axle, a wheel seat and wheels installed on the wheel axle, a multiple of brake grooves facing openings provided on the wheels along the circumference direction, a brake crank connected with a pivot of the wheel seat, and a brake lever provided on the brake crank. When the brake crank is pressed, the brake lever is embedded into the brake groove to prevent the wheels from turning; and when the brake crank is released, the brake lever exits from the brake groove to make the wheels turn freely. However, when the brake lever is pressed just against a bulge between the two brake grooves, the brake lever will fail to brake; and there will be a danger if the carriage continues to go forward or is on a downgrade right at this moment.

### CONTENTS OF THE INVENTION

A purpose of the present utility model is to provide a brake apparatus for baby carriages, which is of a double-brake structure and greatly improves brake reliability and safety.

A technical solution of the present utility model is a brake apparatus for baby carriages, comprising a wheel axle as well as a wheel seat and a wheel hub installed on the wheel axle; a brake crank is pivot-jointed with the wheel axle; the wheel hub is provided with a multiple of brake grooves along the circumference direction; the wheel seat and the brake crank are provided with two brake holes and two arc-shaped grooves corresponding to the brake grooves, respectively; the arc-shaped groove is provided on the edge with an inclined ear extruding along the axial direction; a slope of the inclined ear is provided at the higher end with a stretch of terrace; the two brake holes are provided with a brake lever, respectively, which is inserted from the arc-shaped groove and always pushes against into the brake groove under the action of a pressing spring; the two brake levers are connected with an iron ring at the inner end of the inner side of the brake crank; the iron ring is provided with a stop block installed radially corresponding to the inclined ear; and the stop block is against a slope of the inclined ear.

A further technical solution of the present utility model is a brake apparatus for baby carriages, comprising a wheel axle as well as a wheel seat and a wheel hub installed on the wheel axle; a brake crank is pivot-jointed with the wheel axle; the wheel hub is provided with a multiple of brake grooves along the circumference direction; the wheel seat and the brake crank are provided with two brake holes and two arc-shaped grooves corresponding to the brake grooves, respectively; the arc-shaped groove is provided on the edge with an inclined ear extruding along the axial direction; a slope of the inclined ear is provided at the higher end with a stretch of terrace; the two brake holes are provided with a brake lever, respectively, which is inserted from the arc-shaped groove and always pushes against into the brake groove under the action of a pressing spring; the two brake levers are connected with an iron ring at the inner end of the inner side of the brake crank; the iron ring is provided with a stop block installed radially corresponding to the inclined ear; the stop block is against a slope of the inclined ear; the brake crank is of a U shape, and pivot-jointed with the wheel axle on both sides of the wheel seat; and the wheel axle between the two left and right brake cranks is sheathed with a linked tube, which connects and fixes the two brake cranks.

A more detailed technical solution of the present utility model is a brake apparatus for baby carriages, comprising a wheel axle as well as a wheel seat and a wheel hub installed on the wheel axle; a brake crank is pivot-jointed with the wheel axle; the wheel hub is provided with a multiple of brake grooves along the circumference direction; the wheel seat and the brake crank are provided with two brake holes and two arc-shaped grooves corresponding to the brake grooves, respectively; the arc-shaped groove is provided on the edge with an inclined ear extruding along the axial direction; a slope of the inclined ear is provided at the higher end with a stretch of terrace; the two brake holes are provided with a brake lever, respectively, which is inserted from the arc-shaped groove and always pushes against into the brake groove under the action of a pressing spring; the two brake levers are connected with an iron ring at the inner end of the inner side of the brake crank; the iron ring is provided with a stop block installed radially corresponding to the inclined ear; the stop block is against a slope of the inclined ear; the brake crank is of a U shape, and pivot-jointed with the wheel axle on both sides of the wheel seat; the wheel axle between the two left and right brake cranks is sheathed with a linked tube, which connects and fixes the two brake cranks; the brake hole is of a step shape with a bigger outer end and a smaller inner end; an excircle of the brake lever is also of a step shape with a bigger outer end and a smaller inner end; and the pressing spring is sheathed around the brake lever, with the outer end of the pressing spring against the step of the brake lever, and the inner end against the step of the brake hole.

The advantages of the present utility model are as follows:

1. The present utility model adopts two brake levers provided along the axial direction, which are inserted into the brake groove on the wheel hub at the same time to form a double-brake structure, thus greatly improving brake reliability.

2. The present utility model uses the linked tube to connect and fix the two brake cranks, and a user only need to pedal one of the brake cranks to brake the two wheels at the same time, thus also greatly improving brake safety.

### BRIEF DESCRIPTION OF THE DRAWINGS

The present utility model will be further described below according to drawings and embodiments.

FIG. 1 is a stereoscopic drawing of the present utility model in a brake state.

FIG. 2 is an enlarged drawing of FIG. 1.

FIG. 3 is a stereoscopic drawing of the present utility model in a free state.

FIG. 4 is a front view of the present utility model.

FIG. 5 is a rear view of the present utility model.

FIG. 6 is a top view of the present utility model.

FIG. 7 is a partial sectional view of the present utility model in a brake state.

FIG. 8 is a partial sectional view of the present utility model in a free state.

Where: 1 wheel axle; 2 wheel seat; 3 wheel hub; 4 brake crank; 5 brake groove; 6 brake hole; 7 arc-shaped groove; 8 inclined ear; 9 terrace; 10 pressing spring; 11 brake lever; 12 iron ring; 13 stop block; 14 linked tube; 15 slope.

### DETAILED DESCRIPTION OF THE EMBODIMENTS

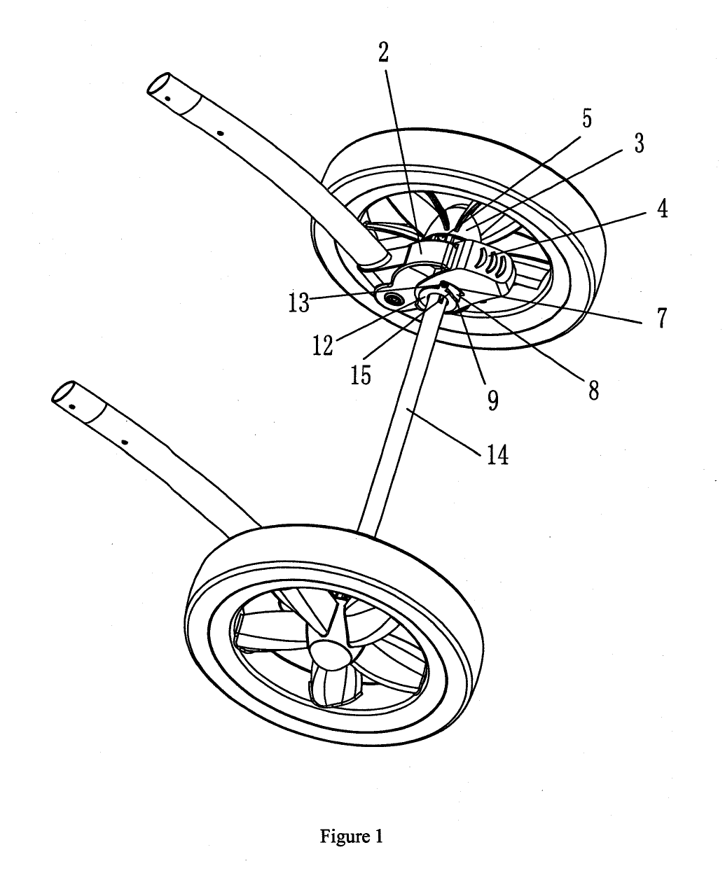

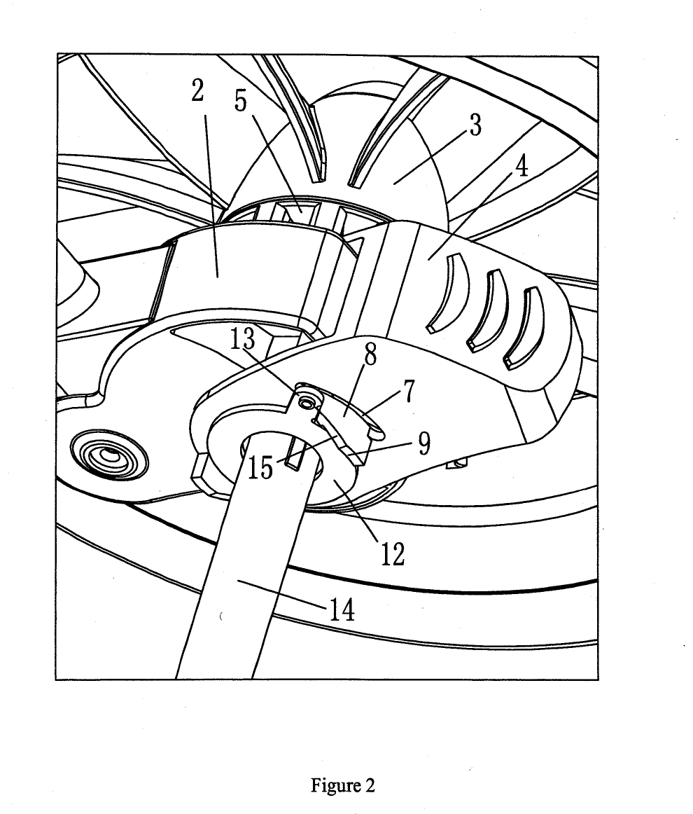

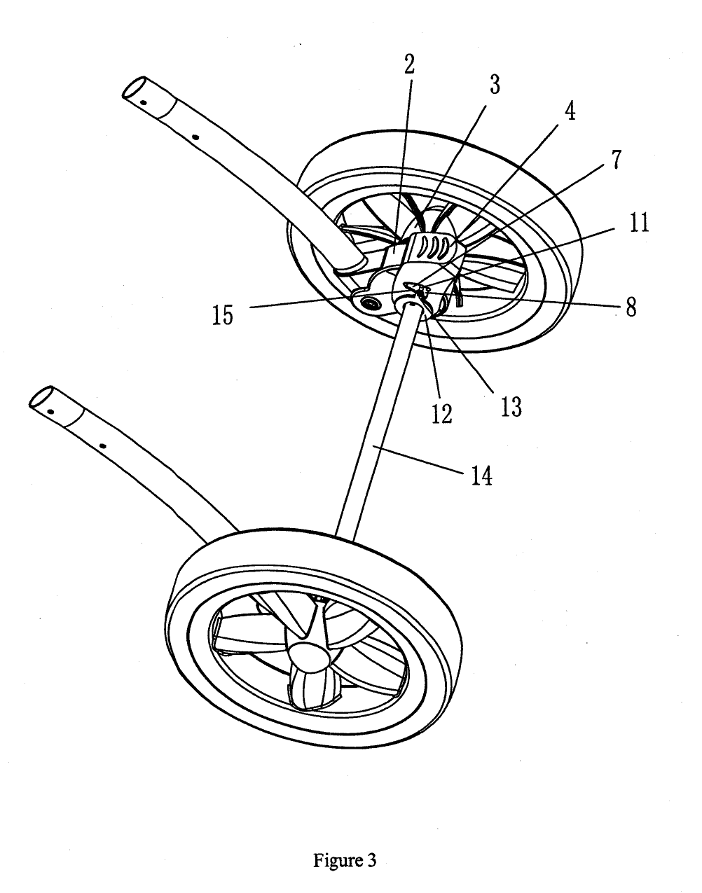

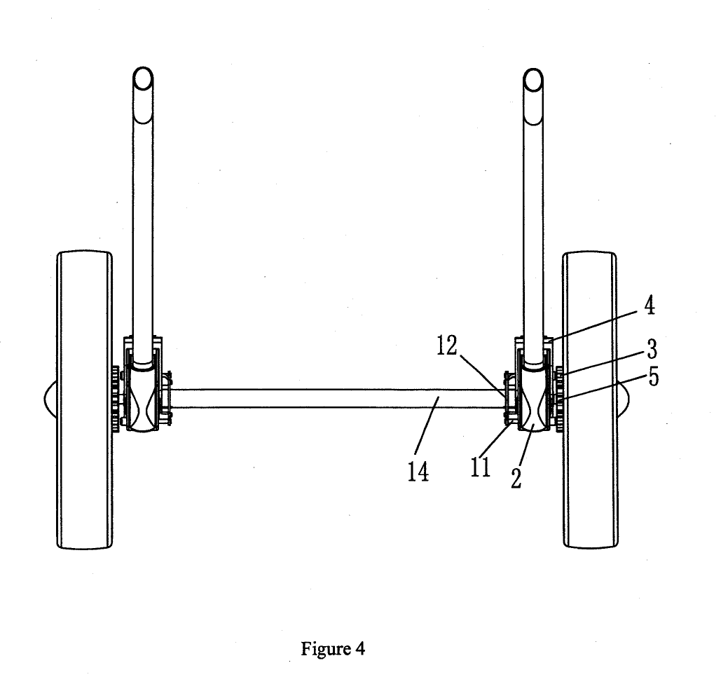

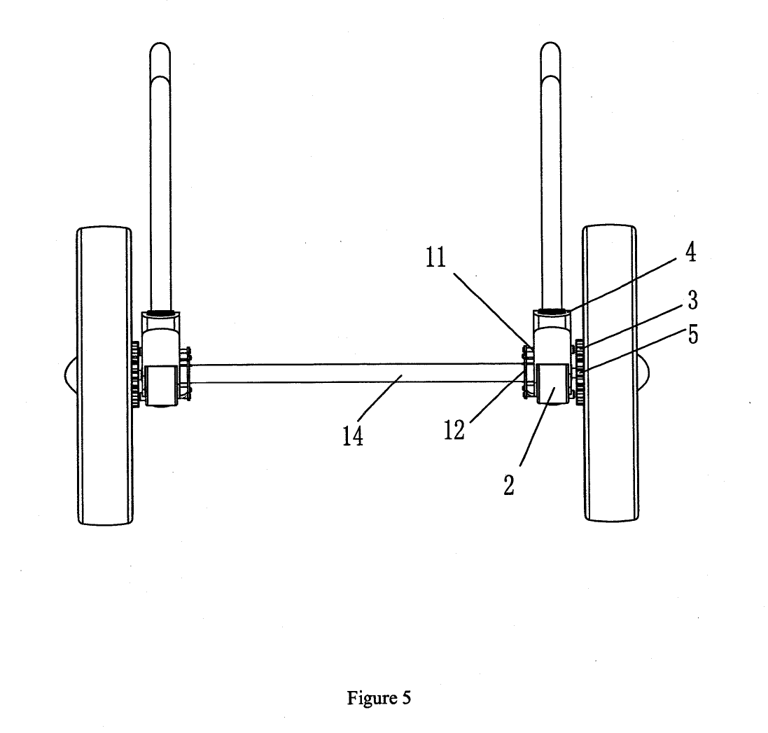

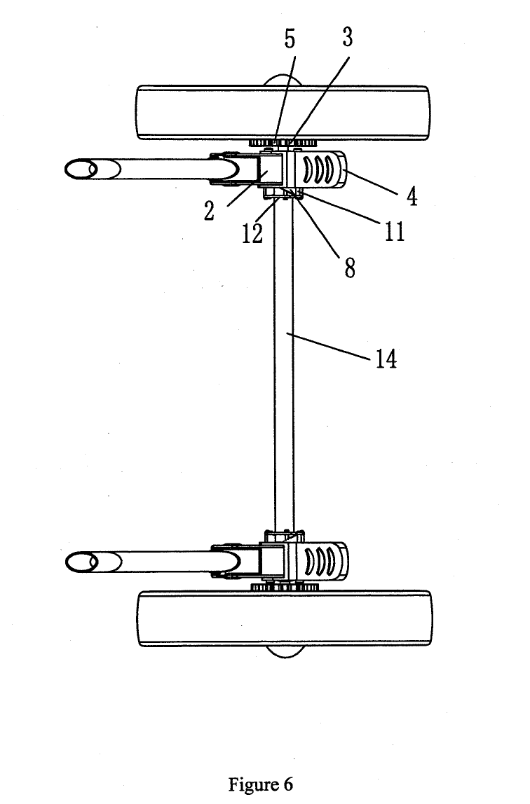

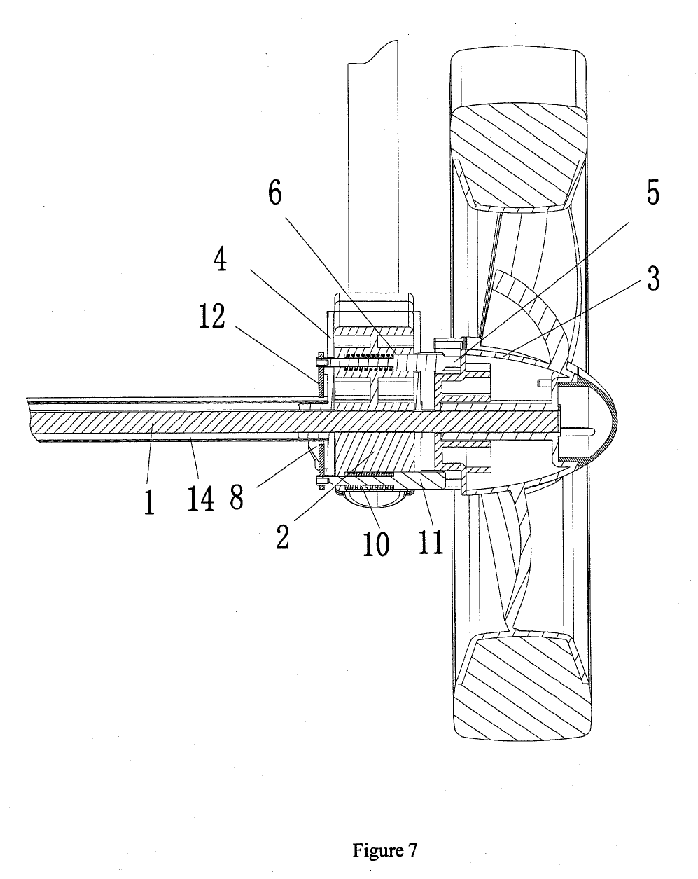

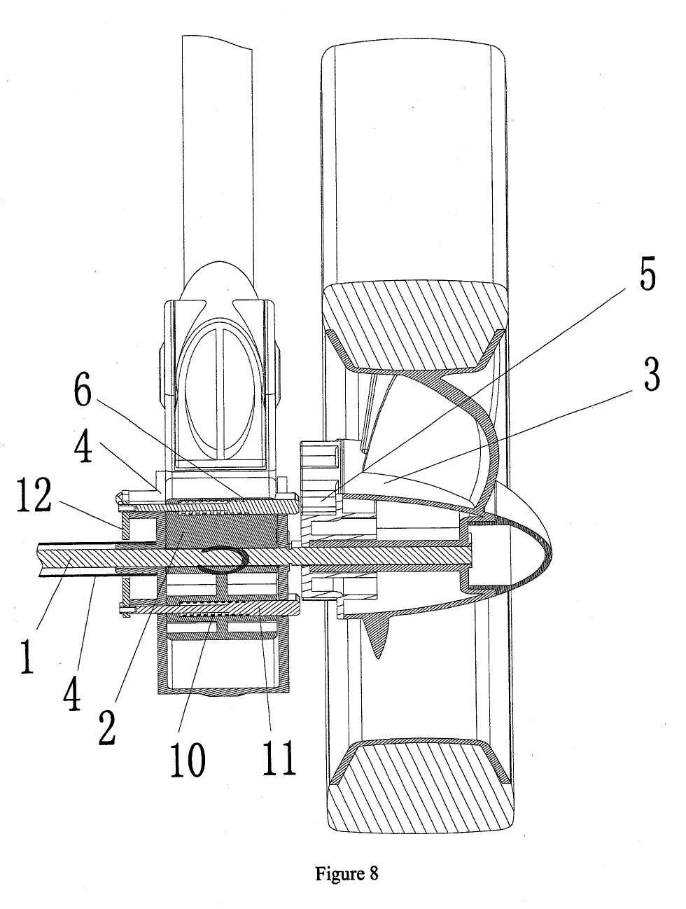

Embodiment: A brake apparatus for baby carriages as shown in FIG. 1, FIG. 2, FIG. 3, FIG. 4, FIG. 5, FIG. 6, FIG. 7, and FIG. 8, comprising a wheel axle 1 as well as a wheel seat 2 and a wheel hub 3 installed on the wheel axle 1; a brake crank 4 is pivot-jointed with the wheel axle 1; the brake crank 4 is of a U shape, and pivot-jointed with the wheel axle 1 on both sides of the wheel seat 2; the wheel axle 1 between the two left and right brake cranks 4 is sheathed with a linked tube 14, which connects and fixes the two brake cranks 4; the wheel hub 3 is provided with a multiple of brake grooves 5 along the circumference direction; the wheel seat 2 and the brake crank 4 are provided with two brake holes 6 and two arc-shaped grooves 7 corresponding to the brake grooves 5, respectively; the arc-shaped groove 7 is provided on the edge with an inclined ear 8 extruding along the axial direction; a slope 15 of the inclined ear 8 is provided at the higher end with a stretch of terrace 9; the two brake holes 6 are provided with a brake lever 11, respectively, which is inserted from the arc-shaped groove 7 and always pushes against into the brake groove 5 under the action of a pressing spring 10; the two brake levers 11 are connected with an iron ring 12 at the inner end of the inner side of the brake crank 4; the iron ring 12 is provided with a stop block 13 installed radially corresponding to the inclined ear 8; the stop block 13 is against the slope 15 of the inclined ear 8; the brake hole 6 is of a step shape with a bigger outer end and a smaller inner end; an excircle of the brake lever 11 is also of a step shape with a bigger outer end and a smaller inner end; and the pressing spring 10 is sheathed around the brake lever 11, with the outer end of the pressing spring 10 against the step of the brake lever 11, and the inner end against the step of the brake hole 6.

To brake a carriage, apply a downward force to the brake crank 4 to make the brake crank 4 turn downward; the slope 15 of the two inclined ears 8 on the brake crank 4 will force the stop block 13 to move along the slope 15 to the lower end of the inclined ear 8; in addition, the pressing spring 10 is against the brake lever 11 that is fixed on the iron ring 12, making the iron ring 12 move in the axial direction parallel with the wheel axle 1 and tightly close to the slope 15 of the inclined ear 8; the iron ring 12 moves from the higher end of the inclined ear 8 to the lower end to produce a perpendicular distance, which makes the thicker end of the brake lever 11 move into and fix in the brake groove 5 of the wheel hub 3; meanwhile, the brake crank 4 delivers a torsional force through the linked tube 14 to another brake set of the same structure, namely the torsional force propels the brake crank 4 to turn along the wheel axle 1; during the turning process, the iron ring 12 will slide to the lower end of the inclined ear 8 along the slope 15 of the two inclined ears 8 on the brake crank 4; and plus elasticity of the pressing spring 10, the thicker end of the brake lever 11 bounces into and fixes in the brake groove 5 of the wheel hub 3, thus realizing the double-brake effect.

Not to brake a carriage, apply a upward force to the brake crank 4, and the slope 15 of the two inclined ears 8 on the brake crank 4 will force the iron ring 12 to move along the slope 15 to the higher end of the inclined ear 8; the iron ring 12 moves from the lower end of the inclined ear 8 to the higher end to produce a perpendicular distance, which makes the iron ring 12 drive the brake lever 11 to move out of the brake groove 5 of the wheel hub 3; here the pressing spring 10 is compressed; when a face of the iron ring 12 is tangent with the terrace 9 at the higher end of the inclined ear 8, the iron ring 12 cannot continue to move; plus elasticity of the pressing spring 10, the iron ring 12 is fixed; meanwhile, the brake crank 4 delivers a torsional force through the linked tube 14 to another brake set of the same structure, namely the torsional force propels the two brake cranks 4 to turn in the same direction along the wheel axle 1; the slope 15 of the two inclined ears 8 on the brake crank 4 will force the iron ring 12 to move along the slope 15 to the higher end of the inclined ear 8, which makes the iron ring 12 drive the brake lever 11 to move out of the brake groove 5 of the wheel hub 3; and when a face of the iron ring 12 is tangent with the terrace 9 at the higher end of the inclined ear 8, the iron ring 12 is fixed, thus realizing the no-braking effect.

The present utility model adopts two brake levers 11 provided along the axial direction, which are inserted into the brake groove 5 on the wheel hub 3 at the same time to form a double-brake structure, thus greatly improving brake reliability; the present utility model uses the linked tube 14 to connect and fix the two brake cranks 4, and a user only need to pedal one of the brake cranks 4 to brake the two wheels at the same time, thus also greatly improving brake safety.

What is claimed is:

1. A brake system of a stroller, comprising a wheel axle (1) as well as a wheel seat (2) and a wheel hub (3) installed on the wheel axle (1); wherein a brake crank (4) is pivot-jointed on the wheel axle (1); the wheel hub (3) is provided with a multiple of brake grooves (5) along the circumference direction; the wheel seat (2) and the brake crank (4) are provided with two brake holes (6) and two arc-shaped grooves (7) corresponding to the brake grooves (5), respectively; the arc-shaped groove (7) is provided on the edge with an inclined ear (8) extruding along the axial direction; a slope (15) of the inclined ear (8) is provided at the higher end with a stretch of terrace (9); the two brake holes (6) are provided with a brake lever (11), respectively, which is inserted from the arc-shaped groove (7) and always pushes against into the brake groove (5) under the action of a pressing spring (10); the two brake levers (11) are connected with an iron ring (12) at the inner end of the inner side of the brake crank (4); the iron ring (12) is provided with a stop block (13) installed radially corresponding to the inclined ear (8); and the stop block (13) is against the slope (15) of the inclined ear (8).

2. The brake system of a stroller, according to claim 1, wherein the brake crank (4) is of a U shape, and pivot-jointed with the wheel axle (1) on both sides of the wheel seat (2).

3. The brake system of a stroller, according to claim 1, wherein the wheel axle (1) between the two left and right brake cranks (4) is sheathed with a linked tube (14), which connects and fixes the two brake cranks (4).

4. The brake system of a stroller, according to claim 1, wherein the brake hole (6) is of a step shape with a bigger outer end and a smaller inner end; an excircle of the brake lever (11) is also of a step shape with a bigger outer end and a smaller inner end; and the pressing spring (10) is sheathed around the brake lever (11), with the outer end of the pressing spring (10) against the step of the brake lever (11), and the inner end against the step of the brake hole (6).
